(19) United States
(12) Patent Application Publication
(10) Pub. No.: US 2004/0028989 A1
(43) Pub. Date: Feb. 12, 2004

(54) Electrochemical device with adjustable-area electrodes using a hydrogen peroxide catholyte

(76) Inventors: Hoi-Cheong Steve Sun, Dayton, NJ (US); Richard T. Whipple, Raritan, NJ (US); Steven Alan Lipp, West Windsor, NJ (US); Yongchi Tian, Princeton, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/315,531

(22) Filed: Dec. 10, 2002

Related U.S. Application Data
(60) Provisional application No. 60/339,118, filed on Dec. 11, 2001.

(51) Int. Cl. H01M 4/86; H01M 8/04

(52) U.S. Cl. 429/40; 429/22

(57) ABSTRACT

Provided is an electrochemical device having an electron source and a hydrogen peroxide solution for reaction to accept the electrons, the device with an anode compartment and a cathode compartment, including (a) a cathode electrode having an area, which can be adjustable, in contact with the cathode compartment of A_{C}; and (b) an anode electrode having an area, which can be adjustable, in contact with the anode compartment of A_{A}, wherein either the cathode or anode electrode area or both are adjustable, such that A_{C}/A_{A}=EAR is adjustable, and wherein, where j_{EC} is the anode current provided by the electron carrier, and j_{TOS} is a diffusion-limited current density for a reaction by oxygen in an oxygen saturated said hydrogen peroxide solution, EAR is selected such that either

(a) EAR≦j_{EC}/j_{OS}, or

(b) j_{EC}/EAR approaches the value of j_{TOS}.

### CROSS-REFERENCE TO RELATED APPLICATIONS

The present application claims priority from U.S. Application No. 60/339,118 filed on Dec. 11, 2001, the disclosure of which is hereby incorporated by reference herein.

### BACKGROUND OF THE INVENTION

Hydrogen peroxide has previously been used as the oxidant in aqueous solutions found in the cathode compartments of conventional fuel cells. It is often desirable to use hydrogen peroxide as an oxidant for many reasons, including its high redox potential. One difficulty with its use, however, is reactive competition from oxygen also generally found in aqueous catholyte solutions including hydrogen peroxide. Oxygen acts as an electron acceptor in competition with the hydrogen peroxide. This reduces the quantity of electrons available to react with the hydrogen peroxide. Due in part to the oxygen reaction's reduced redox potential relative to that of the hydrogen peroxide the oxygen reaction is less desirable. Unfortunately, it is difficult to produce and use solutions of hydrogen peroxide which are substantially free of oxygen as, inter alia, hydrogen peroxide readily reacts to form oxygen. Accordingly, a need exists for a fuel cell using hydrogen peroxide as the oxidant in the cathode compartment which minimizes the oxygen's consumption of available electrons thereby maximizing the overall redox potential of the cathode compartment chemistry.

### SUMMARY OF THE INVENTION

The present invention provides an electrochemical device having an anode compartment and a cathode compartment, an electron source for providing electrons located, or in communication with the anode compartment and a hydrogen peroxide solution to accept the electrons in the cathode compartment. The device also includes an anode electrode having an anode surface area (A_{A}) within said anode compartment and in electrical communication with the electron source. A cathode electrode is provided within the cathode compartment having a cathode surface area (A_{C}) which is in contact with the hydrogen peroxide containing catholyte solution in the cathode compartment. Note that the surface area's A_{A} and A_{C} may, as the context suggests, refer to the entire surface area of the electrode or only the portion in direct contact with an electrolyte (anolyte, electron source, or catholyte containing H₂O₂). The anode electrode is in electrical communication with the cathode electrode. In accordance with the present invention, the device may be characterized by an electrode area ratio (EAR) equal to A_{C}/A_{A}, an anode electron current density (j_{EC}) provided by the electron source, and a diffusion limited electron current density (j_{TOS}) for a reaction by oxygen in the hydrogen peroxide solution when the hydrogen peroxide solution is saturated with oxygen. In accordance with the invention, the anode surface area and the cathode surface area are selected such that

EAR ≦j_{EC}/j_{TOS}.

The present invention also provides methods of constructing devices described herein which include the step of selecting an anode and cathode such that the surface area ratio is governed by the above equation. Methods of operating such devices so as to obtain above 1.1 V are also disclosed.

In one embodiment an electrochemical device of the invention includes a fuel cell.

Another aspect of the invention includes an electrochemical device, including the devices discussed above, in which the anode surface area (A_{A}) and/or the cathode surface area (A_{C}) is adjustable.

In another preferred aspect of the invention, the EAR of an electrochemical device, such as those discussed above, is selected such that

j_{EC}/EAR approaches j_{TOS}.

More preferably, the EAR is selected in an electrochemical device so as to satisfy either the relation:

j_{PM}≧j_{EC}/EAR≧10*j_{TOS}

Even more preferably, the relation:

j_{PM}≧j_{EC}/EAR≧20*j_{TOS}

will be satisfied. Most preferably, the relation:

j_{PM}≧j_{EC}/EAR≧30*j_{TOS}

is satisfied.

Methods of adjusting the A_{A}, A_{C} or both A_{A} and A_{C} so as to satisfy the aforementioned relationships are also contemplated. This can be done by either providing anodes and cathodes having surface areas necessary to satisfy these equations or by providing an anode and/or cathode whose surface area can be adjusted so as to fulfill one or more of the relationships described above.

Another aspect of the invention includes an electrochemical device as described above, which further includes one or more detectors for detecting one or more operating parameters of the electrochemical device. This may also be operatively coupled to one or more adjusters to receive the one or more operating parameters from the one or more detectors and respond to adjust the EAR by changing either or both the A_{C} and the A_{A}.

In another aspect of the invention, the adjuster is a controller adapted to electronically connect to the electrochemical device.

In yet another aspect, the controller is connected to a communications network.

Another aspect of the invention includes an electrochemical device having an anode compartment, a cathode compartment, an electron source for providing electrons in or to the anode compartment and a hydrogen peroxide solution in the cathode compartment. The anode compartment and the cathode compartment are separated, and in a particularly preferred embodiment, separated by a membrane. An anode electrode provided in the anode compartment has an anode surface area (A_{A}) and is in contact with the electron source. A cathode electrode provided in the cathode compartment has a cathode surface area (A_{C}) and is in contact with the hydrogen peroxide. Further, the anode (and thus its A_{A}) is in electrical communication with the cathode (and thus its A_{C}), the electrode area ratio (EAR) of the anode and cathode equal to A_{C}/A_{A}. There is also an anode electron current (j_{EC}) provided by the electron source. The anode surface area and the cathode surface area are selected such that EAR≦1.5. In another embodiment, EAR≦2.0. In another embodiment, EAR≦2.5.

Another aspect of the invention includes an adjustable-area anode electrode for use in an electrochemical device, the device having an electron source for providing electrons in an anode compartment and both a cathode and an electron acceptor to accept electrons in a cathode compartment. The adjustable-area anode electrode has an anode surface area (A_{A}) and is in electrical communication with the electron source in the anode compartment, while the cathode electrode has a cathode surface area (A_{C}) and is in electrical contact with an electron acceptor in the cathode compartment. The adjustable-area anode electrode is in electrical contact with the cathode electrode. The electrode area ratio (EAR) equals A_{C}/A_{A}, and changes in inverse proportion to A_{A}. In another embodiment, the adjustable-area anode electrode is controlled by a controller device.

In another aspect of the invention similar to the adjustable anode electrode above is the adjustable cathode electrode. The adjustable-area cathode electrode having a cathode surface area (A_{C}) is in contact with the electron acceptor in the cathode compartment. An anode electrode having an anode surface area (A_{A}) is disposed within the anode compartment and is in electrical communication with the cathode electrode. In this embodiment, the EAR changes in proportion to A_{C}.

In a further preferred embodiment, both the A_{A} and A_{C} are adjustable.

Another aspect of the invention is a method of adjusting electrical current flow. This is accomplished by varying a surface area of one or more electrodes of an electrochemical device having one or more anode electrodes and one or more cathodes. This is preferably accomplished by providing an adjuster for selectively connecting the anode and cathode electrodes. The method includes defining an electrode area ratio (EAR) equal to the ratio of the surface areas of the cathode electrodes and selectively connecting portions of anode and cathode electrodes, thereby affecting current flow.

In another aspect of the invention, the above method includes using an electron acceptor consisting of a hydrogen peroxide solution.

In a further aspect of the invention, the method includes monitoring one or more operating parameters of the electrochemical device, and changing the EAR in response to the monitored operating parameters.

### BRIEF DESCRIPTION OF THE DRAWINGS

FIG. 1 is a schematic depiction of an electrochemical device in accordance with an embodiment of the present invention;

FIG. 2 is a schematic depiction of a electrochemical device in accordance with an embodiment of the present invention; and

FIG. 3 shows an area adjustable electrode (with component electrodes) in accordance with an embodiment of the invention.

FIG. 4 depicts a schematic diagram of an exemplary fuel cell having a controller in accordance with an embodiment of the invention.

### DETAILED DESCRIPTION

“A_{A}” in accordance with the present invention is a measure of the total surface area in contact with the anolyte of all the anode electrodes in the given device which are in electrical communication with the cathode electrodes that are in contact with the catholyte. Its units are those of area, and in particular embodiments herein described are in terms of square centimeters.

“A_{C}” in accordance with the present invention is a measure of the total surface area in contact with the catholyte of all the cathode electrodes in the given device which are in electrical communication with the anode electrodes that are in contact with the anolyte. Its units are the same as those of A_{A}, preferably, square centimeters.

“EAR” in accordance with the present invention is the “electrode area ratio”, which results from the calculation of A_{C}/A_{A}. It is a ratio, and therefore is a unitless quantity. In reference to the present application, it is believed that the EAR of an electrochemical device, such as those described herein, is related to the rate of a particularly undesirable side reaction of oxygen at the cathode electrode, as described below.

“Redox potential” in accordance with the present invention is a measure (preferably in volts (V)) of the affinity of a substance for electrons—its electronegativity—compared with hydrogen (which is set at 0V). Substances more strongly electronegative than (e.g., capable of oxidizing) hydrogen have positive redox potentials. Substances less electronegative than (e.g., capable of reducing) hydrogen have negative redox potentials. Oxidation and reduction reactions are called “redox reactions”.

The electronegativity of a substance can also be expressed as a redox potential (designated E). Again, the standard is hydrogen, so redox potential is expressed as E=0V. Any substance—atom, ion, or molecule—that is more electronegative than hydrogen is assigned a positive (+) redox potential or positive E; those less electronegative a negative (−) redox potential or negative E.

“Current density” is a measure of the current flowing to or from a unit area of an electrode surface, generally expressed as amps per sq ft or milliamperes per square centimeters (also milliamps per sq ft, etc).

“Diffusion-limited current density” as used herein is the current density, often referred to as limiting current density, corresponding to the maximum transfer rate that a particular species can sustain because of the limitation of diffusion. As an example used below demonstrates, the rate of the oxidation of oxygen at the cathode surface is limited by the ability of dissolved oxygen to diffuse through the catholyte solution into the area surrounding and/or upon the cathode surface where the reaction takes place. The current (and therefore current density) produced by the oxygen reaction is thus limited by the diffusion rate of oxygen. If more oxygen were capable of diffusing through the catholyte to the surface of the cathode at any one time, more reactions could be completed, and more current generated by the reaction of oxygen. This, of course, presumes that the oxygen diffusion rate rather than the rate of delivering electrons to the cathode and protons to its proximity is rate limiting

“j_{EC}” in accordance with the present invention is a measure of the total current density flowing from the anode to the cathode, preferably expressed as milliamps/cm², by virtue of the anode and cathode being in electrical communication through a lead.

“j_{TOS}” in accordance with the present invention is the diffusion-limited current density of a reaction by oxygen in an aqueous hydrogen peroxide solution that is oxygen saturated. The diffusion-limited current density of oxygen is also linearly related to the concentration of peroxide, except when the peroxide concentration is high.

“j_{P}” in accordance with the present invention is the current density due to the hydrogen peroxide reaction in the catholyte.

“j_{O}” in accordance with the present invention is the current density due to the oxygen reaction is in the catholyte. j_{O} can equal but cannot exceed j_{TOS}.

“STP conditions” in accordance with the present invention is standard temperature and pressure as is well known in the art.

“Approaches” in accordance with the present invention is a logical expression denoting that one operand is equal to or nearly equal to another. As used herein, however, it represents a preferable, rather than an exact, equality. For example, the specification and claims herein recite “J_{EC}/EAR approaches J_{TOS}” In this case the EAR is changed so that J_{EC}/EAR and J_{TOS} Are roughly equal. Thus, the condition J_{EC}/EAR=J_{TOS} is preferred over a condition in which J_{EC}/EAR is within 5% Of J_{TOS}, which, in turn is preferred over a condition in which J_{EC}/EAR is within 10% of J_{TOS}, etc. It does not necessarily imply, however that J_{EC}/EAR becomes closer in value to J_{TOS} over time.

Other mathematical operators, such as ‘+’, ‘−’, ‘*’, ‘/’, and comparators, such as ‘=’, ‘<’, ‘>’, ‘≦’, and ‘≧’ have their generally known and accepted usage and meaning. In particular, ‘<’ means “less than”, ‘>’ means “greater than”, ‘≦’ means “less than or equal to”, and ‘≧’ means “greater than or equal to”.

“Electron source” in accordance with the present invention is preferably a component of the anolyte that delivers or supplies electrons to the anode electrode, preferably across the anode electrode surface, such that there arises a proportionality between the number of electrons flowing from the electron source and the surface area of the anode electrode in contact with the anolyte, where other factors do not limit the flow of the current (i.e., a limited ability on the cathode side to consume the transferred electrons). An electron source may be a fuel such as methane or methanol or, for example, a metal anode. In the case of a metal anode it is understood that A_{A} and thus EAR changes as the metal anode is consumed. Metal anodes may be used which have a more constant A_{A} when used in conjunction with a fuel.

“Electron acceptor” in accordance with the present invention is preferably the peroxide solution of the catholyte of the preferred embodiments. It, generally contains H₂O₂, although other peroxide solutions may also be used. Hydrogen peroxide is preferred. Non-peroxide catholytes exhibiting similar competitive reactions with oxygen may also be used instead of or in combination with the peroxide electron acceptor. Electron acceptor as defined here preferably are in solutions whereby the accepted electrons pass from the cathode surface to the dissolved or suspended acceptor, which gives rise to a proportionality between the cathode surface area in contact with the catholyte and the number of electrons so passed (in situations wherein other current limiting factors do not apply). Oxygen itself is also an electron acceptor.

A particularly preferred embodiment of the present invention includes a fuel cell with an anode compartment containing an anode physically separated from a cathode compartment containing a cathode. Physical separation is preferably by a membrane, barrier or battery separator. These will collectively be referred to as “membranes”. The anode and cathode are preferably electronically in a circuit or in electrical communication, usually through a load. Although a membrane is not strictly necessary to practice the invention, one or more are used in several preferred embodiments involving fuel cells. The foregoing definitions and descriptions regarding membranes and associated elements of such fuel cells is provided with these preferred embodiments in mind.

“Associated” in accordance with the present invention can mean a number of things depending on the circumstances. A polypeptide can be associated with a membrane, such as a biocompatible membrane, proton exchange membrane (“PEM”) or a proton tunneling membrane (“PTM”), by being bound to one or more of the surfaces thereof, and/or by being wedged or bound within one or more of the surfaces of the membrane (such as in recesses or pores). An “associated” polypeptide can also be disposed within the interior of the membrane or in a vesicle or lumen contained within the membrane. Polypeptides could also be disposed between successive layers. Polypeptides may be embedded in the membrane as well. Indeed, in a particularly preferred embodiment, the polypeptide is embedded or integrated in the membrane in such a way that it is at least partially exposed through at least one surface of the membrane.

In any of these configurations, what is important is that the associated polypeptide can function within the fuel cell for its intended purpose. A polypeptide which will participate in the transport of protons across the membrane, for example, may participate in a redox reaction or participate in the polypeptide mediated transporting of a proton, or proton-tunneling as a method of moving protons from one side of the membrane to the other.

The term “participate” in the context of transporting a proton from one side of a membrane to the other includes active transport where, for example, the polypeptide physically or chemically “pumps” the proton across the membrane, usually, but not exclusively, against a pH, concentration or charge gradient or any other active transport mechanism. However, participation need not be so limited. The mere presence of the polypeptide in the membrane may alter the structure or properties of the membrane sufficiently to allow a proton to be transported from a relatively low proton concentration to a relatively high proton concentration on the other side of the membrane. This may be, but is not necessarily a passive, non-selective process such as might result from the use of non-selective, passive pore formers or from simple diffusion (PEM membranes). Indeed, in some cases, inactivation of the polypeptides in a membrane provides results that are inferior to similar membranes made without polypeptides at all. These processes (excluding passive diffusion) are collectively referred to as “polypeptide mediated transport” where the presence of the polypeptide plays a role in the transporting of a species across the membrane, in ways other than merely structurally providing a static channel. Stated another way, “polypeptide mediated transport” means that the presence of the polypeptide results in effective transport from one side of the membrane to the other in response to something other than just concentration. “Participate,” in the context of a redox reaction, means that the polypeptide causes or facilitates the oxidation and/or reduction of a species, or conveys to or from that reaction protons, electrons or oxidized or reduced species. In the context of PTMs, “participate” means allowing proton tunneling across the PTM, usually in response to a charge differential on either side of the PTM, as well as potentially participating in redox reaction chemistry. It is possible that a polypeptide associated with a PTM participates in the transport of protons in one or more ways. It may act as a redox enzyme, which reacts with an electron carrier to release protons and electrons. It may actively transport protons across the membrane. It may act as a conduit for getting protons into a PTM and thereafter the PTM, may through proton-tunneling or in some other fashion, complete the transport across the membrane. It could also do any two or all three of these. Conceivably, an associated polypeptide might, in addition to, or instead of one or more of these functions, also participate in the transfer of protons and electrons to an electron carrier.

“Membrane” as used herein generally refers to one or more layers of a synthetic polymeric material forming a sheet, plug or other structure that can be used, alone, or in conjunction with a barrier, and in many embodiments, is substantially impermeable to molecules, atoms and protons. A “biocompatible membrane” is a membrane made of synthetic polymer materials that will not incapacitate or otherwise block all of the functionality of a polypeptide when they are associated with one another. A biocompatible membrane in this context will pump or, through some other form of polypeptide-mediated transport, participate in the transport of protons from one side of a membrane to another.

A PTM is a membrane that is believed to operate using proton-tunneling across quantum wells, as well as by other possible means. PTMs, proton-tunneling and quantum wells are described in further detail below. PEMs are known in the art and are also further described below. A PTM may also be produced using polypeptides that can participate in proton transfer. These may be used in combination of a plurality of membranes. These will all be generically referred to herein as “membranes”.

A “barrier” is a structural support used to support a membrane, where such support is necessary.

“Polypeptide(s)” includes at least one molecule composed of four or more amino acids that is capable of participating in a chemical reaction, often as a catalyst, or participating in the transporting of a molecule, atom, proton or electron from one side of a membrane (a biocompatible membrane, PTM, etc.) to another, or participating in the formation of molecular structures that facilitate or enable such reactions or transport. Preferably, polypeptides participate in the release of protons and/or their transport across a membrane. The polypeptide can be single stranded, multiple stranded, can exist in a single subunit or multiple subunits. It can be made up of exclusively amino acids or combinations of amino acids and other molecules. This can include, for example, pegalated peptides, peptide nucleic acids, peptide mimetics, neucleoprotein complexes. Strands of amino acids that include such modifications as glycosolation are also contemplated. Polypeptides in accordance with the present invention are generally biological molecules or derivatives or conjugates of biological molecules. Polypeptides can therefore include molecules that can be isolated, as well as molecules that can be produced by recombinant technology or which must be, in whole or in part, chemically synthesized. The term therefore encompasses naturally occurring proteins and enzymes, mutants of same, derivatives and conjugates of same, as well as wholly synthetic amino acid sequences and derivatives and conjugates thereof. In one preferred embodiment, polypeptides in accordance with the present invention can participate in the transporting of molecules, atoms, protons and/or electrons from one side of a membrane to another side thereof, can participate in oxidation or reduction, or are charge driven proton pumping polypeptides such as DH⁻ Complex I (also referred to as “Complex 1”), see Tran et al., “Requirement for the proton pumping NADH dehydrogenase I of Escherichia coli in respiration of NADH to fumarate and its bioenergetic implications,” Eur. J. Biochem. 244: 155, 1997.

This application includes not only this text and the drawings referenced herein, but also hereby incorporates by reference in their entirety U.S. patent application Ser. No. 10/213,530 filed Aug. 7, 2002 entitled BIOCOMPATIBLE MEMBRANES AND FUEL CELLS PRODUCED THEREWITH, and U.S. Patent Application No. 60/415,686 filed Oct. 3, 2002 entitled PROTON-TUNNELING MEMBRANES AND FUEL CELLS.

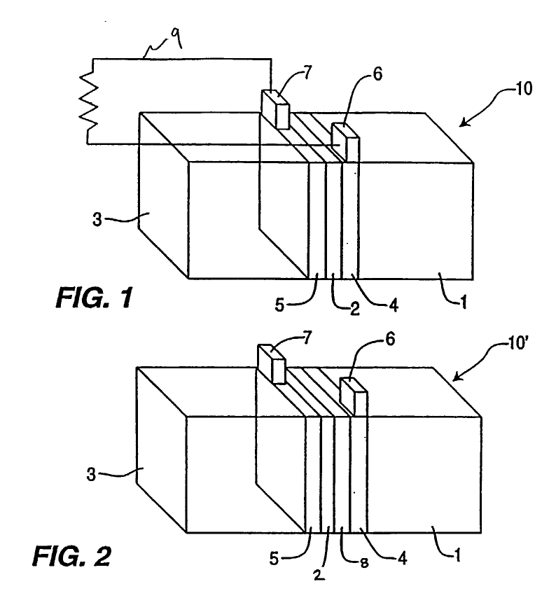

FIG. 1 depicts an exemplary electrochemical device of the present invention, in this case, a fuel cell 10. The fuel cell 10 includes an anode compartment 3 and a cathode compartment 1, separated by a membrane 2, which may include a barrier (not separately pictured). The anode and cathode compartments 3, 1 include an anode 5, and a cathode 4, respectively in electrical communication via a circuit or lead 9 (pictured here as a resistor).

The barrier, if employed in this embodiment is preferably comprised of a dielectric material, such as KAPTON available from DuPont such as a layer 1 mil thick and may be porous or may contain one or more apertures of, for example, 100 microns width. The aperture size may alternatively be smaller, such as 25 microns. Dielectric as used herein refers to material that normally prevents charged particles, whether electrons, protons or other charged species from passing through the material.

The barrier preferably includes apertures which are preferably filled or covered with a membrane 2, which can be a biocompatible membrane, proton tunneling membrane (PTM), or proton exchange membrane (PEM). Any other type of membrane usable in this fuel cell is also contemplated. These membranes preferably allow the passage of protons and optionally other positive species, but are most preferably impermeable to other chemical species.

One method of forming a biocompatible membrane useful in a preferred embodiment of the present invention is as follows:

Form a solution of synthetic polymer material in a solvent or mixed solvent system. The solution can be a mixture of two or more block copolymers, although it may contain one or more polymers and/or copolymers. The solution preferably contains 1 to 90% w/v synthetic polymer material, more preferably 2 to 70%, or yet more preferably 3 to 20% w/v. Seven % w/v is particularly preferred.

One or more polypeptides (typically with solubilizing detergent) are placed in solution, either separately or by being added to the existing polymer solution. Where the solvent used to solubilize the synthetic polymer materials is the same, or of similar characteristics and solubility to that which can solubilize the polypeptide, it is usually more convenient to add the polypeptide to the polymer solution directly. Otherwise, the two or more solutions containing the synthetic polymer materials and the polypeptide must be mixed, possibly with an additional cosolvent or solubilizer. Most often, the solvent used for the polypeptide is aqueous.

The amount of polypeptide used will vary with the type of polypeptide used, the nature and function of the membrane, the environment in which it will be used, etc. The amount of polypeptide may be important to certain applications such as fuel cells where, in general, the higher the concentration of polypeptide per square centimeter of surface area, the higher the rate of proton transfer per unit area (in terms of current). In general, however, as long as some polypeptide is present and functional, and as long as the amount of polypeptide used does not prevent membrane formation or render the membrane unstable, then any amount of polypeptide is possible. Generally, the amount of polypeptide will be at least about 1%, more preferably about 5%, even more preferably 10%, and still more preferably at least about 20% and most preferably 30% or more by weight based on the final weight of the membrane. The amount of polypeptide to solvent can be as low as 1 mg/ml. Preferably, the concentration is from about 5 mg/ml to about 50 mg/ml. More preferably the concentration is from about 10 mg/ml to about 30 mg/ml. Complex 1 is a preferred polypeptide.

Suitable solubilizing and/or stabilizing agents such as cosolvents, detergents and the like may also be needed, particularly in connection with the polypeptide solution. Solubilizing detergents are commonly found at the 0.1% to 1.0% concentration level, and more preferably up to about 0.5% is contemplated. Such detergents include ionic detergents: Sodium dodecyl sulfate, Sodium N-dodecyl sarcosinate, N-dodecyl Beta-D-glucopyranoside, Octyl-Beta-D-glucopyranoside, dodecyl-maltoside, decyl, undecyl, tetradecyl-maltoside (in general, an alkyl chain of about 8 carbons or more bonded to a sugar as a general form of an ionic detergent) octyl-beta-D-glucoside and polyoxytheylane (9) dodecyl-ether, C₁₂E₉, as well as non-ionic detergents, such as triton X-100, or Nonidet P-40. Also useful are certain polymers, typically diblock copolymers which exhibit surfactant properties, such as BASF's Pluronic series, or Disperplast (BYK-Chemie). Stabilizing agents may also include PEG, PEO and the like in amounts of up to about 1.0% concentration.

Mixing of these solutions is often a relatively simple matter and can be accomplished by hand or with automated mixing tools. Heating or cooling may also be useful in membrane formation depending on the solvents and polymers used. In general, rapidly evaporating solvents tend to form membranes better with cooling while extremely slowly evaporating solvents would most likely benefit from a slight degree of heating. One can examine the boiling point of solvents used to select those with the most favorable characteristics provided they are appropriate for the polymer used.

One must, of course, however consider also the need to incorporate the polypeptide into the solvent polymer mixture, which can be a nontrivial matter. It is possible, for example, to mix 5 microliters of a detergent solubilized complex 1 (0.15% w/v dodecyl maltoside) having 10 mg/ml of complex 1 into 95 microliters of a mixture of a 3.2% w/v polystyrene-polybutadiene-polystyrene triblock copolymer (a completely hydrophobic triblock Sold under the trademark STYROLUX 3G55, Lot No. 7453064P, available from BASF in a 50/50 mixture of acetone and hexane and to deposit same in a manner that will allow for membrane formation. In this case, the final mixture included about 5% v/v of water, 0.75% w/w complex 1 relative to the weight of the synthetic polymer material. Generally, the solutions are sufficiently stable at room temperature to be useful for at least about 30 minutes, provided that the solvents do not evaporate during that time. They also can be stored overnight, or longer, generally under refrigerated conditions.

A volume of the final solution including both the polypeptide(s) and the synthetic polymer materials is formed into a membrane and allowed to at least partially dry, thereby removing at least a portion of the solvent. It is possible to completely dry some of the membranes produced in accordance with the invention or to substantially dry same. By substantially dry it is meant that there may be some residual solvent, up to about 15%, which is often retained even if left out at room temperature for several hours. In one example using aperatures of 100 microns in diameter in a 1 mil thick barrier, 4 microliters of the solution may be added dropwise by pipet onto the aperatures so as to form membranes. Each 4 microliters of solution will produce membranes in about 200 aperatures with the resulting membranes 130 having a thickness of about 25 microns.

The above-described membrane is a biocompatible membrane and complex 1 is a polypeptide that can participate in a redox reaction to liberate both protons and electrons. But this particular membrane is also a PTM. PTMs include at least one layer of material, generally a synthetic polymeric material, which is preferably impermeable to liquids, solids and gases, and most importantly to the passage of protons driven by a differential in concentration or concentration gradient. At the very least, the majority of the flow of protons across the PTM, as measured by the flow current, will be the result of something other than proton permeability. Yet, PTMs are not dielectric (unable to carry current and/or permit flow of protons). Without wishing to be bound by any particular theory of operation, it is believed that PTMs will allow protons to pass based on charge differential rather than a concentration effect. More specifically, protons interact with the cationic n bonds of certain groups found in specifically selected polymeric materials used to construct the PTM and are driven into and across the PTM by excess positive charge on one side of the PTM. Generally speaking, however, as long as the membrane is both “relatively proton impermeable,” meaning the majority of the flow of protons across the PTM, as measured by the flow of current, is a result of something other than proton permeability (preferably but not necessarily proton-tunneling) and nondielectric, it can be considered a PTM.

Quantum mechanics provides a theoretical foundation for such membranes. Unlike other ions, which have both a nucleus and electrons, protons are fundamental particles. They exhibit quantum mechanical behavior. While this quantum mechanical behavior is weaker than that of electrons, it is greater than that of other ions. This is in part due to their size, which also lies between that of an electron and that of other ions. Protons thus may be trapped in a quantum well or may tunnel through a quantum well when enough energy is available. It is expected that the kinetic energy of a proton does not have to be larger than the quantum well for tunneling to occur, but that the tunneling probability increases with increasing kinetic energy of the proton and/or the shallowness of the proton well. PTMs may be associated with polypeptides, as is the case in the above example, or may be used in conjunction with a biocompatible membrane. Thus, in this case, it would be appropriate to designate membranes 131 either or both a biocompatible membrane or a PTM.

The membrane used may alternatively be a PEM. These membranes are permeable to protons, which are driven across the membrane from the anode to the cathode primarily by a concentration gradient that is established by the chemistries of the anode and cathode compartments. PEMs are well known to those of ordinary skill in the area of fuel cells.

Although any of a biocompatible membrane, PTM or PEM (or indeed, any other suitable membrane, barrier or separator) may be used as a membrane, biocompatible membranes or PTMs are particularly preferred. Also, if the membrane does not include a polypeptide able to cleave protons and electrons from electron sources, such a chemical, usually a polypeptide must be provided in the anode compartment 3.

In operation, the fuel in the anode compartment 3 donates electrons, which pass to the anode 5, to the anode connector 7, through a circuit 9 to the cathode connector 6, to the cathode 4. Protons or some other positively charged species are also provided by the fuel in the anode compartment 3 and migrate or pass through the membrane 2 to the cathode compartment 1. There, the electrons at the cathode 4 and the protons or positive species in the cathode compartment 1 are available to react with species in the catholyte, preferably hydrogen peroxide.

Anodes and cathode electrodes can be made of any electrically conductive material, which is otherwise generally unreactive with the elements of the electrochemical device. The anode 5 and cathode 4 are preferably made of metals or carbon. It is also possible to construct cathodes and/or anodes of materials that are consumed redox reactions, although this will have an effect on the surface areas of the electrodes in contact with the catholyte and anolyte, respectively.

In the anode compartment 3 of a preferred embodiment of the invention, any of several reactions involving a fuel may occur to produce protons or another positive species and electrons. For example, a typical anode compartment reaction takes place when hydrogen gas contacts the anode electrode 5:

2H₂O+H₂-------→2H₃O+2e⁻

This reaction is an example of chemistry in the anode compartment 3 of an electrochemical device such as a fuel cell. Many other reactions involving other fuels may be used, so long as they result in the production of electrons and protons or other positive species in the anode compartment 3 that can be used in the cathode compartment 1.

In a preferred embodiment, the corresponding reaction at the cathode electrode 4 can be any reaction that consumes the produced electrons with a useful redox potential.

Without wishing to be bound by any theory of operation, three of the possible reactions that may occur within the cathode compartment containing H₂O, H₂O₂ and O₂ are notable. These reactions, with their associated electrochemical potential, are:

| | ELECTROCHEMICAL |
|---|---|
| REACTION | POTENTIAL (E) |
| (A) H⁺ + e^{- --------> ½H}₂ | 0 V |
| (B) ½O₂ + 2H⁺ + 2e⁻ --------> H₂O | 0.4 V to 1.23 V* |
| (C) H₂O₂ + 2H⁺ + 2e⁻ --------> 2H₂O | 0.88 V to 1.76 V* |

*Depending on pH

Of these reactions, reaction (A) does not occur at a rate sufficient for consideration herein. The practical competition, therefore, is between the oxygen reaction (B) and the hydrogen peroxide reaction (C).

The oxygen reaction, if available, is experimentally observed to be the favored route for consuming electrons transferred to the cathode compartment (i.e., one mole of O₂ consumes 4 moles of protons and electrons in reaction (B), versus consumption of only two moles of protons and electrons by one mole of hydrogen peroxide in reaction (C)). The oxygen reaction is favored for thermodynamic and reaction irreversibility reasons.

Of these reactions, the hydrogen peroxide reaction (C) is preferred for providing greater power output, as evidenced by the electrochemical potential. There is therefore a design preference for an electrochemical device in accordance with the present invention to operate using cathode chemistry based primarily on the hydrogen peroxide reaction, which further allows control over the rate of the competing oxygen reaction (B) so as to minimize the oxygen reaction (B) and thereby maximize the electrochemical potential of the cathode compartment chemistry.

Such an electrochemical device using hydrogen peroxide in the cathode compartment, however, also generates oxygen by the following reaction:

2H₂O₂-------→2H₂O+O₂ (D)

Thus, oxygen is always present in such a device and the oxygen reaction (B) competes with the hydrogen peroxide reaction (C) to consume the electrons.

In accordance with an embodiment of the present invention, an electrochemical device is advantageously designed to increase the dominance (rate or degree) of the hydrogen peroxide reaction (C) relative to the rate of the oxygen reaction (B) in the cathode compartment. It has been discovered that one can take advantage of the diffusion-limited current density of oxygen with respect to the solution in the cathode compartment and the area and materials of the cathode electrode of the cathode compartment to increase the rate of the hydrogen peroxide reaction relative to the oxygen reaction. This may be accomplished by limiting the surface area of the cathode and providing a relatively large number of electrons for reaction there. The significantly lower diffusion-limited current density of oxygen compared with that of hydrogen peroxide means that the oxygen consumed in reaction at the cathode surface is replaced much more slowly than the hydrogen peroxide so consumed. Thus the oxygen reaction rate quickly falls to a rate supportable by the diffusion of available oxygen to the cathode surface, while the consumed hydrogen peroxide is more quickly replaced by diffusion.

Without wishing to be bound to any particular theory of operation, it is believed that the relatively lower surface area of the cathode in accordance with the present invention has a number of effects. First, it increases the current density of electrons at the cathode's surface. Second, the reduced surface area means that molecules, such as oxygen and hydrogen peroxide, must compete to accept electrons. This, coupled with the lower relative oxygen concentration and/or the lower diffusion rate of oxygen verses hydrogen peroxide in the catholyte, means that once oxygen adjacent the cathode is consumed, the only species left to react is hydrogen peroxide. Additional oxygen is slower to diffuse to the surface of the cathode, further favoring the hydrogen peroxide reaction. In a slower system, either because of low current density caused by less productive anode chemistry or a larger cathode, or both, the oxygen can more effectively compete to accept electrons. In fact, in these types of systems, the hydrogen peroxide may play only an incidental role by actually forming oxygen which then reacts with the cathode. The result of the present invention, however, is much greater voltage and current then that which could be realized in a comparable system which does not harness the potential of the hydrogen peroxide.

While the relationship between electrode size and ratio, diffusion, concentration and current density is complex, what has been discovered can be established, if not completely explained, by observation. In a system which readily supplies current, electrons and protons (e.g., very productive anode chemistry, efficient collection and transport of electrons by the anode and effective transport of positive charge across the membrane such that neither electrons or protons are rate or reaction limiting), a relative reduction in cathode size can actually increase current and voltage in an otherwise identical system. It has been observed that when a cathode is withdrawn from such a system, slowly, voltage and current initially decrease. However, eventually, as the amount of surface area of the cathode is decreased further (surface area in contact with catholyte is actually what is being reduced in this case) the voltage and current will increase.

It is believed that this will take place because the reaction chemistry within the cathode compartment is such that the conversion of O₂ to H₂O is maximized leaving all of the remaining electrons and protons to act upon the peroxide, a process which increases the output of the system. But whether or not the explanations herein are accurate, the relationships between current, surface area and the like are correct.

The invention preferably uses an aqueous cathode solution comprised of at least 0.5%, 5%, or 30% (w/w) hydrogen peroxide so that the concentration of hydrogen peroxide is much greater than that of oxygen. The concentration of oxygen in a peroxide aqueous catholyte cannot exceed 4 mMolar, whereas the concentration of peroxide is minimally over 100 mMolar. In such a solution, the theoretical diffusion-limited current density for the oxygen reaction, j_{TOS}, assuming oxygen saturation of the catholyte solution is, for example, 100 μA/cm² (of cathode electrode surface area). The theoretical diffusion-limited (maximum) current density for the hydrogen peroxide reaction can be, for example, for a 30% solution of hydrogen peroxide, 170 mA/cm², or about 1,700 times the current generating capacity of the oxygen reaction. A 0.6% hydrogen peroxide solution still has 34 times the current generating capacity of the oxygen reaction. Assuming a cathode electrode area of 1 cm², and an anode that pumps 300 μA, then the maximum current density for oxygen times the area suggests that the oxygen reaction accounts for only 100 μA in consuming the electrons provided from the anode. Consumption of the remaining 200 μA of electrons is provided by the more desirable, high voltage, hydrogen peroxide reaction. Thus, given the higher capacity of the hydrogen peroxide reaction, the area of the cathode electrode can be selected at a relatively smaller size to assure efficient utilization of the hydrogen peroxide reaction. From another perspective, assuming a small cathode (as compared with the anode) and a large supply of electrons and protons at the cathode, the smaller diffusion-limited current density of oxygen means that the oxygen reaction will be starved for reactants before the hydrogen peroxide reaction.

It has been found that if the current density of anode current provided by the electron carrier is j_{EC}, the anode electrode area is A_{A}, the cathode electrode area is A_{C}, the operative current density due to the hydrogen peroxide reaction is j_{P}, and the operative current density due to the oxygen reaction is j_{O} (and the operative current density due to the oxygen reaction when the cathode compartment solution is oxygen saturated is j_{OS}), then,

j_{EC}·A_{A}=(j_{O}+j_{P})·A_{C} (i)

or,

j_{EC}=j_{O}·A_{C}/A_{A}+j_{P}·A_{C}/A_{A} (ii)

Assuming j_{P} is zero or a positive number, and oxygen saturation (such that j_{O} is “j_{OS}”), then j_{P}·A_{C}/A_{A} is necessarily a positive term. Therefore,

j_{EC}>=j_{OS}·A_{C}/A_{A} (iii)

or

A_{C}/A_{A}<=j_{EC}/j_{OS} (iv)

In other words, A_{C}/A_{A}, which is also herein referred to as the electrode area ratio (EAR) will be minimized such that A_{C} can provide no more current due to the oxygen reaction than could be pumped, assuming maximal oxygen contamination. Since oxygen levels will typically be less than saturation after initial operation of the fuel cell, a contribution from the peroxide reaction will occur.

For example, if j_{EC} is 33 μA/cm², and j_{OS} is 99 μA/cm², then the A_{C}/A_{A} ratio, which can be termed the electrode area ratio (EAR), is ⅓. Formula (i) may be re-written as follows:

j_{EC}/EAR=j_{O}+j_{P} (v)

Thus, it is clear that where j_{EC}/EAR becomes 10-fold 20-fold or 30-fold greater than the maximum j_{O} (hereinafter referred to as “j_{TOS}”), then the contribution of j_{O} is modest. The current density j_{TOS} is selected as the standard since this theoretical value should be greater than j_{OS}. Thus the operating standard leads to EAR values that provide more current contribution through the hydrogen peroxide reaction.

In a preferred embodiment of the present invention, where j_{PM} is the maximum available current density available due to hydrogen peroxide, the electrode areas are selected such that

j_{PM}>=j_{EC}/EAR>=x·j_{TOS} (vi)

Where x is preferably 10, more preferably 20, or most preferably 30.

Formula (v) implies, given the above assumptions and a j_{PM} of 170 mA/cm² (or 170,000 μA/cm²), in the range available for 30% hydrogen peroxide, that EAR can be as low as 0.000194.

Nonetheless, since j_{EC} values in excess of 1000 μA/cm² are obtainable and desirable, high EAR values will conform to formula (iii) and (iv). Thus, in one preferred embodiment, EAR is greater than or equal to 1.5. In another EAR is greater than or equal to 2.0. In another EAR is greater than or equal to 2.5.

The current density of the anode current (j_{EC}) can be measured by: setting up a full electrochemical cell (using device including a membrane such as described above) with an electron source in the anode compartment; a peroxide solution in the cathode compartment; a large area graphite cathode electrode (at least three times the surface area of the anode electrode), an anode electrode of a pre-determined composition and surface area; and using an electrometer in current mode (or a high sensitivity ammeter), connecting the poles of the meter to the anode and cathode of the cell. The measured current divided by the surface area of the anode is j_{EC}.

The operative current density due to the oxygen reaction when the cathode compartment solution is oxygen saturated (j_{OS)} can be measured by: setting up a full electrochemical cell; constantly bubbling air into the cathode compartment solution; using a large surface area gold anode electrode, at least five times the surface area of the cathode electrode, and a cathode electrode; and using an electrometer in current mode (or high sensitivity ammeter), connecting the poles of the meter to the electrodes of the cell. The measured current divided by the surface area of the cathode electrode is j_{OS}.

One possible way to calculate the maximum operative current density due to the oxygen reaction (j_{TOS}) is calculated based on Fick's Law of diffusion. See, Bockris and Reddy, Modern Electrochemistry (Plenum, New York, 1970), pp. 1058-1070, and Handbook of Chemistry, pp. 5.3-5.6. Since the oxygen reaction consumes 4 electrons per oxygen molecule, the relevant equation is:

j=D[4nq/δ] (vii)

In the equation, the diffusion constant is estimated at 1×10⁻⁵ cm²/sec, and δ is estimated at 0.05 cm. For oxygen saturation in water at 25° C., the concentration of O₂ is n=7.5×10¹⁷ molecules per cm³. The electron charge is estimated at q=1.6×10⁻¹⁹ coulomb. Thus, j_{TOS}=9.6×10⁻⁵ A/cm² or ˜100 μA/cm².

Measurement of the operative current density due to the hydrogen peroxide reaction (j_{P}) free of the oxygen reaction contribution is difficult. It is assumed for the purposes of this invention that j_{P} is proportional to the hydrogen peroxide weight percent and calculated from a j_{PM} of 170 mA/cm² for 30% hydrogen peroxide. This value was obtained for standard temperature and pressure (“STP”) conditions using the equation above (ix), with the H₂O₂ concentration of n=2.8×10²² molecules per cm^{3.}

The cathode reactions (B) and (C) result in a net production of water, which, if significant, can be dealt with by, for example, providing for space for overflow liquid, or providing for vapor-phase exhaust. A number of electron acceptor molecules are often solids at operating temperatures or solutes in a carrier liquid, in which case the cathode compartment 1 should be adapted to carry such non-gaseous material.

It is possible that use of hydrogen peroxide as the electron acceptor molecule may damage the polypeptides of the membrane (if used) and any other species in the anode compartment 3. In that instance, a scavenger for such electron acceptor molecules can be used in the electrochemical device to prevent hydrogen peroxide or other damaging electron acceptor molecules from entering the anode compartment. Such a scavenger can be, for example, the enzyme catalase (2H₂O₂-->2H₂O+O₂), especially where conditions at the anode electrode are not effective to catalyze electron transfer to O₂. Alternatively, the scavenger can be any noble metal, such as gold or platinum. Such a scavenger, if an enzyme, can be covalently linked to a solid support material. Alternatively, as pictured in FIG. 2, a membrane 8 between the anode compartment 3 and the cathode compartment 1 is provided and has at most limited permeability to hydrogen peroxide.

In an embodiment of the invention in which a lowered voltage output is desired, the lowered voltage output is preferably attained with a proper choice of anode and cathode electrodes. For example, if the membrane separating the cathode and anode is not sufficiently strong to withstand the full peroxide voltage or if there is a desire to maintain a low voltage output from the cell for other reasons, hydrogen peroxide can still be used as a concentrated source of oxygen to be supplied to the cathode. Biasing the cathode chemistry towards the oxygen reaction can be accomplished by maintaining a large cathode active surface area relative to the anode surface area. The direct conversion of peroxide will be inhibited and the decomposition of peroxide would yield oxygen to keep the cell working. For example, consider formula (v) as re-written below:

j_{P}=j_{EC}/EAR−j_{O} (viii)

In this case, EAR can be adjusted to have j_{EC}/EAR approach the value of j_{O}, so that j_{P} approaches or reaches zero, effectively suppressing the hydrogen peroxide reaction (C).

In a particularly preferred embodiment of the invention, a fuel cell is provided in which the anode electrode area or cathode electrode area can be adjusted or tuned to provide an appropriate EAR. Such adjustment can be done at the factory, periodically during the life of the fuel cell, or dynamically.

In a dynamically adjusted fuel cell of a preferred embodiment of the invention, the EAR is advantageously adjusted to account for drops in j_{EC} during the consumption of fuel, due to degradation of anode chemistry components, or as needed to vary power output. For dynamic adjustment, the operating current preferably provides a proxy for j_{EC} for use in determining adjustments needed in EAR. Other useful parameters that can be monitored are voltage, power, current, and other parameters as known in the art. Data from monitors (detectors) for such parameters can be sent to the controller described below, with the controller responding as appropriate to adjust the EAR.

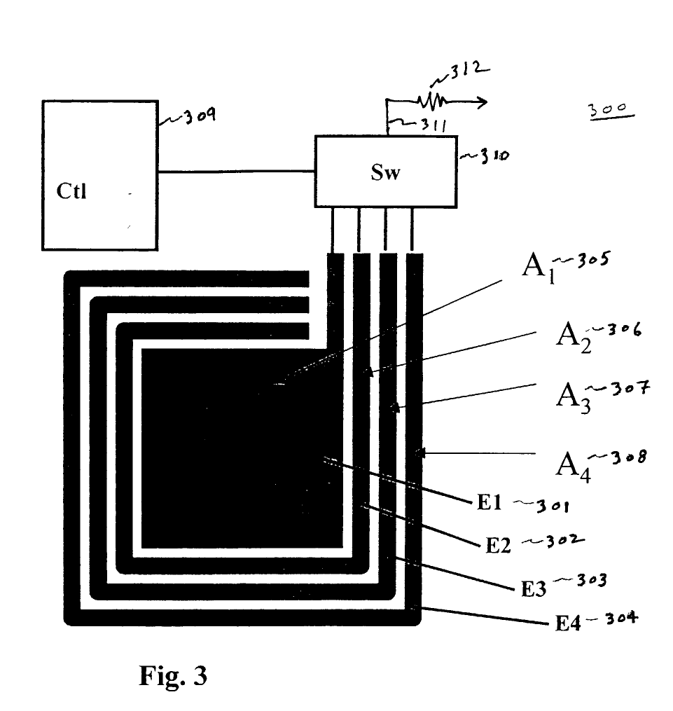

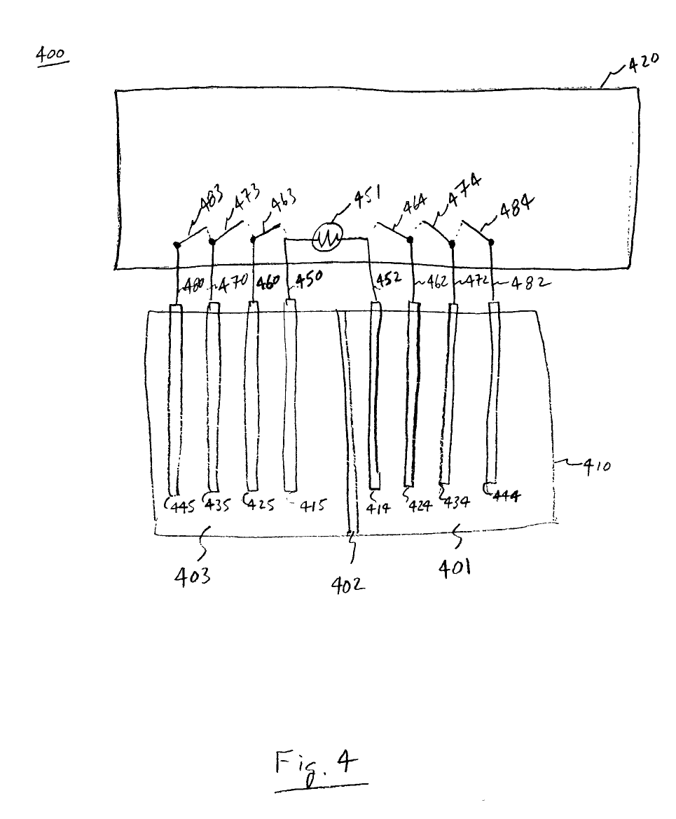

One way of adjusting EAR dynamically is illustrated in FIG. 3, which illustrates four electrodes, E1 through E4, 301-304, with corresponding areas A₁ through A₄, 305-308. The electrodes can be connected to the circuit 311 and 312 manually, with appropriate jumpers, or with a switching device Sw 310, as is known in the art. The switching device Sw 310 can be controlled with an electronic controller Ctl 309, which can be incorporated into the switching device Sw 310. Recognizing that the drawing is not to scale, if one supposed A₁ =2A₂, A₂=2A₃, and A₃=2A₄, then the different combinations of electrodes that can be joined to the circuit provides 2ⁿ−1 different sizes, with n being the number of electrodes, when n=4 such that there are 15 different sizes. Each such different size is a multiple of A4. Additional electrodes can be introduced to provide even greater range. In this preferred embodiment, the controller Ctl 309 preferably signals the switching device Sw 310 to connect or disconnect any or all the electrodes E1-E4, 301-304, differentially increasing or decreasing the effective surface area of the electrode (anode or cathode) assembly so controlled. For example, where electrodes E1-E4, 301-304 comprise the cathode, when a change is made from only E1 301 connected to all of E1-E4 301-304 connected, the EAR is nearly doubled.

FIG. 4 illustrates schematically another electrochemical device in accordance with a preferred embodiment of the invention allowing dynamic adjustment to the EAR. In this illustration, a fuel cell with controller is provided 400. The fuel cell 410 preferably includes an anode compartment 403 and a cathode compartment 401, separated by a membrane 402, such as one of those described above. The anode compartment 403 contains an anolyte and anode electrodes 415, 425, 435, 445. The anode electrodes are advantageously of a known surface area, and are preferably equivalent in surface area, although such surface area equivalency is not required.

The cathode compartment 401 similarly and preferably includes catholyte, preferably a hydrogen peroxide solution, and cathode electrodes 414, 424, 434, 444. The cathode electrodes likewise are preferably of known and equivalent surface areas, although equivalence in surface area is not required. Anode electrode 415 is connected via electrical lead 450 lead to a circuit 451 (depicted herein as a resister) within controller 420, which is subsequently connected via lead 452 with cathode electrode 414. Of course, the circuit 451 can also be located outside of the controller 420, and can be any circuit that needs to receive power.

Anode electrode 425 is preferably connected via lead 460 to a switch 463 within a controller 420, allowing contact with lead 450 when switch 463 is in the closed position. Similarly, anode electrode 435 is connected via lead 470 to switch 473, which allows contact with lead 450 via lead 460 when switch 473 is in the closed position. Again, anode 445 is similarly connected to a switch 483 via lead 480. When switch 483 is closed, lead 480 is connected to lead 450 via leads 470 and 460.

Cathode electrode 424 is connected to a switch 464 in the controller 420. When the switch 464 is closed, cathode electrode 424 is thusly connected to lean 452. Likewise, cathode electrodes 434 and 444 are connected to switches 474 and 484 via leads 472 and 482. In their closed positions, starting with switch 474 and then switch 484, connection is provided to lead 452 via lead 462 and switch 464.

The controller is therefore advantageously and preferably able to control the surface area of the anode and cathode electrodes in electrical contact with each other by the closing or opening of switches 463, 473, 483, 464, 474, 484. These switches 463, 473, 483, 464, 474, 484 may be controlled by any of several means, including mechanical and/or electrical, and they serve effectively as an adjuster of EAS for the fuel cell. The controller 420 may also include various detectors or monitors (not depicted) as is well known in the art. These may serve to provide feedback to a logic component (also not pictured) which, in turn, may preferably act to adjust the fuel cell's EAR by opening and closing switches 463, 473, 483, 464, 474, 484, as needed.

In another preferred embodiment, the controller and optional monitors are provided by a second device adapted to be electronically connected to the adjusters of the electrochemical device. In operation the controller receives data, possibly from the monitors, and executes logic to operate one or more switching devices to increase or decrease EAR as necessary or desirable. Thus, for example, adjustment may be conducted using this process at the factory, or at distinct times during the life of the electrochemical device.

In a particularly preferred embodiment, the controller can be a microprocessor-based device executing a programmable algorithm, which in turn may be interconnected with other microprocessors, even over a communications network. Such a communications network is preferably local in scope, but the invention is not limited to such a local network. Indeed, the controller may even be connected to the Internet, allowing the monitoring and control of the electrochemical device's EAR from any connected Internet node.

Other switching mechanisms can also be used. For example, the switch for the anodes can be formed of four single pull single throw switches, with one end of each switch connected to the circuit 451. The other end of each of the four switches is connected to one of the electrode 415, 425, 435 & 445. Then any combination of the electrodes in the anode compartment 403 could be connected to the circuit 451. A similar single pull single throw switch can be used to connect the cathode electrodes to the circuit 451. Thus, for maximum flexibility, a second switch having four single pull single throw switches is provided to selectively connect any combination of the electrodes 454, 424, 434 and 444 to the circuit 451.

The switch for the cathode electrodes would have four single pull single throw switches with one end of each switch connected to the circuit 451 and the other end of each switch individually connected to one of the electrodes 414, 424 and 444. This allows any combination of the cathode electrodes 414, 424, 434 and 444 to be switched into the circuit 451 while any combination of the anode electrodes 415, 425, 435 and 445 to be also switched into the circuit 451. Each switch can be computer controlled.

The hydrogen peroxide solutions used in this invention are preferably at least 0.5%, 5%, or 30% (w/w) hydrogen peroxide. The non-hydrogen peroxide components of the solution are preferably non-metallic electrolytes in aqueous solution.

For a fuel cell in which it is desired to maximize the hydrogen peroxide reaction, material selections are made for the components of the fuel cell that minimize production of metal ions that can catalyze reaction (D), which generates O₂.

1. A fuel cell comprising: an anode compartment, a cathode compartment, a membrane disposed between said anode and said cathode compartments said membrane being capable of passing positive charge from said anode compartment to said cathode compartment, an anode disposed within said anode compartment having an anode surface area A_{A}, a cathode disposed within said cathode compartment having a cathode surface area A_{C}, wherein A_{A} is in electrical communication with A_{C} and there being an electrode area ratio (EAR) equal to A_{C}/A_{A}, an electron source for providing electrons disposed within said anode compartment in electrical communication with said anode and an aqueous peroxide catholyte solution in said cathode compartment in contact with A_{C}, wherein the A_{C} and A_{A} are selected such that EAR≦J_{EC}/J_{TOS}, where J_{EC} is the anode electron current provided by said electron source and J_{TOS} is the diffusion limited electron current density for oxygen in said peroxide catholyte solution saturated with oxygen.

2. The fuel cell according to claim 1, wherein at least one of A_{A} or A_{C} is adjustable.

3. The fuel cell according to claim 1, wherein the EAR is selected such that
J_{EC}/EAR approaches J_{TOS}.

4. The fuel cell according to claim 1, wherein the A_{C} and A_{A} are selected so that the maximum available current density due to electron consumption by reaction of peroxide (J_{PM}) is given by the relation
j_{PM}≧j_{EC}/EAR≧10*j_{TOS}

5. The fuel cell according to claim 4, wherein the A_{C} and A_{A} are selected so that the maximum available current density due to electron consumption by reaction of hydrogen peroxide (J_{PM}) is given by the relation
j_{PM}≧j_{EC}/EAR≧20*j_{TOS}.

6. The fuel cell according to claim 5, wherein the A_{C} and A_{A} are selected so that the maximum available current density due to electron consumption by reaction of hydrogen peroxide (J_{PM}) is given by the relation
j_{PM}≧j_{EC}/(A_{C}/A_{A})≧30*j_{TOS}.

7. The fuel cell according to claim 1, wherein said peroxide is hydrogen peroxide.

8. The fuel cell according to claim 1, further comprising:
one or more detectors for detecting one or more operating parameters of the electrochemical device; and
one or more adjusters to receive said one or more operating parameters from said one or more detectors and respond to adjust the EAR by changing at least one of A_{C} or A_{A}.

9. The fuel cell according to claim 8, wherein said adjuster is a controller adapted to electronically communicate to said fuel cell.

10. The fuel cell according to claim 8, wherein said controller is connected to a communications network.

11. The fuel cell according to claim 1, wherein EAR≦2.5.

12. The fuel cell according to claim 1, wherein EAR≦2.0.

13. The fuel cell according to claim 1, wherein EAR≦1.5.

14. A fuel cell comprising: an anode compartment, a cathode compartment, a membrane disposed between said anode and said cathode compartments said membrane being capable of passing positive charge from said anode compartment to said cathode compartment, an anode disposed within said anode compartment having an anode surface area A_{A}, a cathode disposed within said cathode compartment having a cathode surface area A_{C}, wherein A_{A} is in electrical communication with A_{C} and there being an electrode area ratio (EAR) equal to A_{C}/A_{A} and wherein EAR≦2.5, an electron source for providing electrons disposed within said anode compartment in electrical communication with said anode and an aqueous peroxide catholyte solution in said cathode compartment in contact with A_{C}.

15. The fuel cell according to claim 14, wherein EAR≦2.0.

16. The fuel cell according to claim 14, wherein EAR≦1.5.

17. The fuel cell according to claim 14, wherein the voltage or current obtained is greater than the amount which could be obtained from oxygen in an oxygen saturated peroxide catholyte solution.

18. The fuel cell according to claims 14, wherein said catholyte includes hydrogen peroxide and oxygen and wherein said EAR is selected such that the maximum available current density due to electron consumption by reaction of hydrogen peroxide (J_{PM}) is ≧10*j_{TOS} where j_{TOS} is the diffusion limited electron current density for oxygen in a peroxide catholyte solution saturated with oxygen.

19. The fuel cell according to claim 18, wherein said catholyte includes hydrogen peroxide and oxygen and wherein said EAR is selected such that the maximum available current density due to electron consumption by reaction of hydrogen peroxide
(J_{PM}) is ≧20*j_{TOS} where j_{TOS} is the diffusion limited electron current density for oxygen in a peroxide catholyte solution saturated with oxygen.

20. The fuel cell according to claim 19, wherein said catholyte includes hydrogen peroxide and oxygen and wherein said EAR is selected such that the maximum available current density due to electron consumption by reaction of hydrogen peroxide
(J_{PM}) is ≧30*j_{TOS} where j_{TOS} is the diffusion limited electron current density for oxygen in a peroxide catholyte solution saturated with oxygen.

21. The fuel cell of claim 14, wherein said peroxide is hydrogen peroxide.

22. The fuel cell according to claim 14, further comprising:
one or more detectors for detecting one or more operating parameters of the electrochemical device; and
one or more adjusters to receive said one or more operating parameters from said one or more detectors and respond to adjust the EAR by changing at least one of A_{C}or A_{A}.

23. The fuel cell according to claim 22, wherein said adjuster is a controller adapted to electronically communicate to said fuel cell.

24. The fuel cell according to claim 23, wherein said controller is connected to a communications network.

25. The fuel cell according to claim 14 wherein at least one of A_{A} or A_{C} is adjustable to provide a desired EAR.

26. A method of adjusting electrical current flow by varying a surface area of one or more electrodes of a fuel cell comprising: an anode compartment, a cathode compartment, a membrane disposed between said anode and said cathode compartments said membrane being capable of passing positive charge from said anode compartment to said cathode compartment, an anode disposed within said anode compartment having an anode surface area A_{A}, a cathode disposed within said cathode compartment having a cathode surface area A_{C}, wherein A_{A} is in electrical communication with A_{C} and there being an electrode area ratio (EAR) equal to A_{C}/A_{A}, an electron source for providing electrons disposed within said anode compartment in electrical communication with said anode and an aqueous peroxide catholyte solution in said cathode compartment in contact with A_{C}, the method comprising
changing the EAR by selectively connecting said anode and said cathode electrodes, thereby affecting current flow.

27. The method according to claim 26, wherein the electron acceptor is a hydrogen peroxide solution.

28. The method according to claim 27, further comprising
adjusting EAR such that, where j_{EC} is the anode current provided by the electron source, and j_{TOS} is a diffusion limited current density for a reaction by oxygen in an oxygen saturated hydrogen peroxide solution used as the electron acceptor
EAR≦j_{EC}/j_{TOS}.

29. The method according to claim 27, further comprising
adjusting EAR such that, where j_{EC} is the anode current provided by the electron source, and j_{TOS} is a diffusion limited current density for a reaction by oxygen in an oxygen saturated hydrogen peroxide solution used as the electron acceptor
j_{EC}/EAR approaches j_{TOS}.

30. The method according to claim 26, further comprising
monitoring one or more operating parameters of the electrochemical device; and
changing the EAR in response to the monitored operating parameters.
